(19) United States
(12) Patent Application Publication
(10) Pub. No.: US 2023/0397119 A1
(43) Pub. Date: Dec. 7, 2023

(54) COMMUNICATION DEVICE, COMMUNICATION METHOD, PROGRAM, AND COMMUNICATION SYSTEM

(71) Applicant: SONY SEMICONDUCTOR SOLUTIONS CORPORATION, KANAGAWA (JP)

(72) Inventors: ATSUSHI MORI, KANAGAWA (JP); TAKANOBU KOBASHIRI, KANAGAWA (JP); KARIN UNO, KANAGAWA (JP)

(21) Appl. No.: 18/250,856

(22) PCT Filed: Oct. 25, 2021
(86) PCT No.: PCT/JP2021/039302

§ 371 Date: Apr. 27, 2023

(30) Foreign Application Priority Data
Nov. 5, 2020 (JP) 2020-184873

(51) Int. Cl. H04W 52/02

(52) U.S. Cl. CPC H04W 52/0248

(57) ABSTRACT

The present disclosure relates to a communication device, a communication method, a program, and a communication system which can reduce power consumption relating to reception. A buffer amount of a reception buffer that buffers transmission data in a case of receiving the transmission data is monitored, the transmission data buffered in the reception buffer is not read until the buffer amount exceeds a predetermined threshold value, the transmission data buffered in the reception buffer is read in a case where the buffer amount exceeds the predetermined threshold value, and reception processing of the transmission data is executed. The present disclosure can be applied to the communication system.

### TECHNICAL FIELD

The present disclosure relates to a communication device, a communication method, a program, and a communication system, and more particularly, to a communication device, a communication method, a program, and a communication system which can reduce power consumption of a receiving-side device.

### BACKGROUND ART

A lot of communication equipment used for near field communication typified by Bluetooth (registered trademark) is small and lightweight, and therefore often has a small battery capacity.

In such communication equipment, in order to extend the usable time of the battery, it is necessary to reduce the power consumption relating to communication.

Thus, a technique of reducing the power consumption relating to communication by lowering the operating frequency of a transmitting-side device has been proposed (refer to Patent Document 1).

### CITATION LIST

### Patent Document

Patent Document 1: Japanese Patent Application Laid-Open No. 2010-218063

### SUMMARY OF THE INVENTION

### Problems to be Solved by the Invention

However, in the technique of Patent Document 1, by lowering a transmission rate on a transmitting side, it is possible to reduce the power consumption of the transmitting-side device, but it is not possible to reduce the power consumption of the receiving-side device.

The present disclosure has been made in view of such a situation, and an object thereof is to reduce the power consumption relating to communication on a receiving side.

### Solutions to Problems

A communication device, a program, and a communication system according to an aspect of the present disclosure are a communication device, a program, and a communication system which include a reception buffer monitoring unit that monitors a reception buffer that buffers transmission data; and a reading unit that reads the transmission data from the buffer on the basis of a monitoring result of the reception buffer monitoring unit.

A communication method according to an aspect of the present disclosure is a communication method including steps of monitoring a reception buffer that buffers transmission data; and reading the transmission data from the reception buffer on the basis of a monitoring result.

In an aspect of the present disclosure, a reception buffer that buffers transmission data is monitored; and the transmission data is read from the reception buffer on the basis of a monitoring result.

### BRIEF DESCRIPTION OF DRAWINGS

FIG. 1 is a diagram illustrating a communication method of a Request/Response method.

FIG. 2 is a diagram illustrating a communication method of a Credit Based Flow Control method.

FIG. 3 is a diagram illustrating a transmission amount in a case where the transmission rate is high and a transmission amount in a case where the transmission rate is low in the communication method of the Credit Based Flow Control method.

FIG. 4 is a diagram illustrating an overview of a communication method of the present disclosure.

FIG. 5 is a diagram illustrating a configuration example of a communication system of a first embodiment of the present disclosure.

FIG. 6 is a flowchart illustrating communication processing in the communication system in FIG. 5.

FIG. 7 is a diagram illustrating a configuration example of a communication device of a second embodiment of the present disclosure.

FIG. 8 is a flowchart illustrating communication processing in the communication device in FIG. 7.

FIG. 9 is a diagram illustrating a configuration example of a communication device of a third embodiment of the present disclosure.

FIG. 10 is a flowchart illustrating communication processing in the communication device in FIG. 9.

FIG. 11 is a diagram illustrating a configuration example of a communication device of a fourth embodiment of the present disclosure.

FIG. 12 is a flowchart illustrating communication processing in the communication device in FIG. 11.

FIG. 13 is a diagram illustrating a configuration example of a general-purpose computer.

### MODE FOR CARRYING OUT THE INVENTION

Hereinafter, preferred embodiments of the present disclosure will be described in detail with reference to the accompanying drawings. Note that, in the present specification and the drawings, constituents having substantially the same functional configuration will be assigned the same reference numerals and redundant description will be omitted.

Hereinafter, modes for carrying out the present technology will be described. The description will be given in the following order.
1. Overview of present disclosure
2. First Embodiment
3. Second Embodiment
4. Third Embodiment
5. Fourth Embodiment
6. Example executed by software

### 1. Overview of Present Disclosure

<Request/Response Method>

The present disclosure is to reduce the power consumption relating to communication on a receiving side.

In describing an overview of the present disclosure, two communication methods of a Request/Response method and a Credit Based Flow Control method will be described.

In the Request/Response method, in a case where a transmitting-side communication device performs data transmission, a receiving-side communication device receives and buffers data, and transmits a reception response indicating the reception to the transmitting-side communication device. In a case of receiving the reception response, the transmitting-side communication device repeats processing of continuously performing data transmission to the receiving-side communication device.

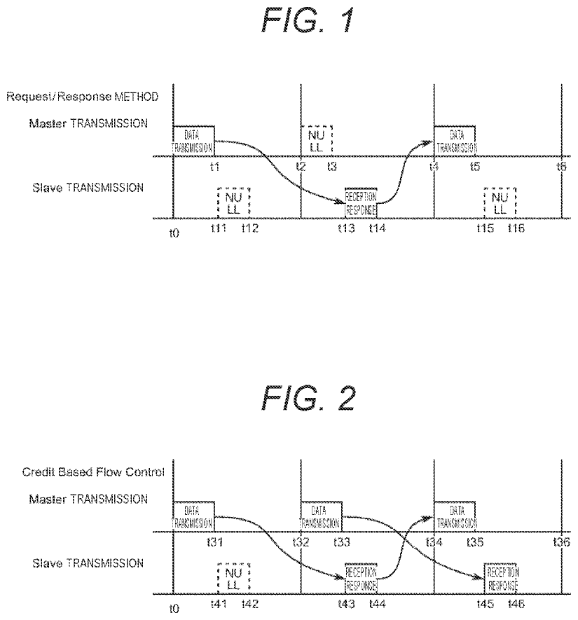

More specifically, as indicated by the Master transmission in FIG. 1, in a case where a master device, which is the transmitting-side communication device, performs data transmission in times t0 to t1, the receiving-side communication device receives data transmitted from the transmitting-side device, and temporarily stores the data in a buffer.

Then, as indicated by the Slave transmission in FIG. 1, in times t13 to t14, the receiving-side communication device generates a reception response indicating that the transmission data has been received, and transmits the reception response to the transmitting-side communication device.

Note that, times t11 to t12 represent, by a dotted line, a timing at which the reception response is transmitted in a case where there is data transmission before times t0 to t1, but in FIG. 1, since there is no data transmission before times t0 to t1, “NULL” is notated to indicate that the reception response is not transmitted.

In a case where the reception response is received, in times t4 to t5, the transmitting-side communication device performs data transmission again, and repeats the similar processing until there is no more data to transmit.

As described above, in the Request/Response method, in a case where it is considered that times t0 to t2, times t2 to t4, and the like form phases, the data transmission in the transmitting-side communication device and the transmission of the reception response in the receiving-side communication device are alternately performed for each phase.

That is, in the Request/Response method, in a case where the transmitting-side communication device performs data transmission in the first phase in times t0 to t2, the receiving-side communication device receives the transmitted data.

In the next phase in times t2 to t4, in a case where the receiving-side communication device transmits a reception response, the transmitting-side communication device receives the reception response.

Moreover, in the next phase in times t4 to t6, the transmitting-side communication device performs the next data transmission, and the receiving-side communication device receives the transmitted data.

In this manner, in the communication method of the Request/Response method, since the data transmission from the transmitting-side communication device and the transmission of the reception response from the receiving-side communication device are alternately executed in units of phases, the transmission efficiency is poor.

<Credit Based Flow Control Method>

In the Credit Based Flow Control method, in a case where the transmitting-side communication device performs data transmission, the receiving-side communication device receives and buffers data, and transmits a reception response including credit information indicating a free space of the buffer, to the transmitting-side communication device.

In a case where there is a free space of the buffer on a receiving side, the transmitting-side communication device performs data transmission of a data amount with the free space as an upper limit, with respect to the receiving-side communication device.

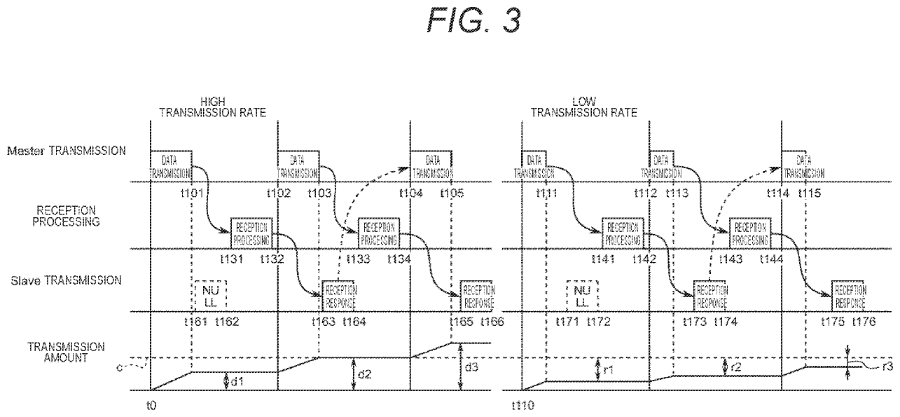

More specifically, as indicated by the Master transmission in FIG. 2, the master device, which is the transmitting-side communication device, performs data transmission in times t0 to t31 in the phase in times t0 to t32, and the receiving-side communication device receives the transmitted data, and temporarily stores the data in the buffer. Then, the receiving-side communication device reads the data stored in the buffer and sequentially executes reception processing (signal processing of the received data).

In times t32 to t33 in the next phase in times t32 to t34, the master device, which is a transmitting-side communication device, performs the data transmission, and the receiving-side communication device receives the transmitted data, and temporarily stores the data in the buffer. Then, the receiving-side communication device reads the data stored in the buffer, and sequentially executes the reception processing.

Moreover, as indicated by the Slave transmission in FIG. 2, in times t43 to t44, the receiving-side communication device reads the data buffered at the timing in times t0 to t31 and sequentially executes the reception processing to generate the reception response including the credit information indicating the free space of the released buffer, and transmits the reception response to the transmitting-side communication device. In response to this, the transmitting-side communication device receives the reception response including the credit information transmitted from the receiving-side communication device.

Furthermore, as indicated by the Master transmission in FIG. 2, in times t34 to t35 in the next phase in times t34 to t36, the transmitting-side communication device performs the data transmission in a case where it is confirmed that there is a free space of the buffer on the basis of the credit information included in the reception response most recently received from the receiving-side communication device. Note that, in the first processing, the data transmission is performed on the basis of an initial value of the credit information. A notification of the initial value of the credit information may be provided from the receiving side to the transmitting side before the transmission is started, or a fixed value may be used.

Moreover, as indicated by the Slave transmission in FIG. 2, in times t45 to t46 in the phase in times t34 to t36, the receiving-side communication device generates the reception response including the credit information indicating the free space of the buffer released by the data received as the data transmission in times t32 to t33 being read out and subjected to the reception processing, and transmits the reception response to the transmitting-side communication device.

That is, in a case where the transmitting-side communication device performs the data transmission with respect to the receiving-side communication device, the receiving-side communication device receives and buffers the transmitted data, sequentially executes the reception processing, and transmits a response signal including the credit information indicating the free space of the buffer released by the reception processing, to the transmitting-side communication device.

After that, in a case where it is confirmed that there is a free space of the buffer on the basis of the credit information included in the reception response transmitted from the receiving-side communication device, the transmitting-side communication device repeats processing of performing the data transmission.

In this manner, in the Credit Based Flow Control method, in each of the phases in times t0 to t32, in times t32 to t34, and the like, since the data transmission by the transmitting-side communication device and the transmission of the reception response including the credit information by the receiving-side communication device are performed in the same phase, the transmission efficiency is higher than the transmission efficiency of the communication method of the Request/Response method.

<Relationship between transmission rate and free space of buffer in Credit Based Flow Control method> As described above, in a case of the Credit Based Flow Control method, the transmitting-side communication device recognizes the free space of the buffer of the receiving-side communication device on the basis of the reception response including the credit information transmitted from the receiving-side communication device, and performs the data transmission in a case where there is a free space.

Here, for example, as illustrated in the left part in FIG. 3, a case of performing the data transmission at a relatively high transmission rate is considered.

Note that, in FIG. 3, in the uppermost row notated as “Master transmission”, the data transmission timing in the transmitting-side communication device is illustrated. Furthermore, the reception processing, the Slave transmission, and the transmission amount are notated below the uppermost row in order from the top, and respectively indicate the timing at which the reception processing (reading transmission data stored in the buffer and performing signal processing relating to the reception) is performed, the timing at which the reception response including the credit information is transmitted, and a cumulative total amount of data by the data transmission, in the receiving-side communication device. Here, a threshold value C indicated by a dotted line in the transmission amount corresponds to the capacity of the buffer.

As indicated by the Master transmission in FIG. 3, in times t0 to t101 in the first phase in times t0 to t102, in a case where the transmitting-side communication device performs the data transmission, the receiving-side communication device temporarily stores the transmitted data in the buffer. By this processing, the total amount of the transmission amount is changed from 0 to d1.

Next, as indicated by the reception processing, in times t131 to 132, the receiving-side communication device reads the transmitted data that is temporarily stored in the buffer, and executes the reception processing (signal processing relating to the reception).

That is, the transmitted data that is temporarily stored in the buffer is read and used by the reception processing (signal processing), and thus a part of the buffer is released so that the free space is increased.

Note that, as indicated by the Slave transmission, the timing in times t161 to t162 is a timing at which the reception response including the credit information as the information on the free space of the buffer is transmitted by the receiving-side communication device, but in the first processing, there is no reception processing immediately before, “NULL” is notated to indicate that there is no processing by a dotted line.

Therefore, in times t102 to t103 in the next phase in times t102 to t104, the transmitting-side communication device does not receive a reception response from the receiving-side communication device, and performs new data transmission on the premise that there is a free space of the buffer of the receiving-side communication device. Therefore, the receiving-side communication device temporarily stores the transmission data in the buffer. By this processing, the total amount of the transmission amount is changed from d1 to d2, and reaches the threshold value c (=d2) corresponding to the capacity of the buffer.

Next, as indicated by the Slave transmission, in times t163 to t164, the receiving-side communication device transmits the reception response including the credit information indicating the free space of the buffer released by the reception processing performed in times t131 to 132, to the transmitting-side communication device. In response to this, the transmitting-side communication device receives the reception response including the credit information transmitted from the receiving-side communication device.

Moreover, in times t133 to 134, the receiving-side communication device reads the transmission data that is temporarily stored in the buffer at the timing in times t102 to t103, and executes the reception processing (signal processing relating to the reception).

Moreover, in times t104 to t105 in the phase after time t104, the transmitting-side communication device performs new data transmission in a case where there is a free space of the buffer of the receiving-side communication device on the basis of the credit information included in the reception response that is most recently received and is transmitted from the receiving-side communication device at the timing in times t163 to t164. By this processing, the total amount of the transmission amount is changed from d2 to d3 (>c).

Then, as indicated by the Slave transmission, in times t165 to t166, the receiving-side communication device transmits the reception response including the credit information indicating the free space of the buffer released by the reception processing performed in times t133 to 134, to the transmitting-side communication device.

That is, in a case where the transmission rate is relatively high, the transmission amount is large, and the free space of the buffer of the receiving-side communication device tends to be insufficient. Therefore, in order to avoid a buffer overflow, it is required for the receiving-side communication device to secure a free space of the buffer by reading the data from the buffer and performing the reception processing (signal processing relating to the reception) at a frequency close to the frequency at which the transmitting-side communication device performs the data transmission.

On the other hand, as illustrated in the right part in FIG. 3, it is considered that the data transmission has a relatively low transmission rate, the data transmission is performed three times in times t0 to t111, in times t112 to t113, and in times t114 to t115, the reception processing is performed in times t141 to t142 and in times t143 to t144, and the reception response including the credit information is transmitted in times t173 to 174 and in times t175 to t176.

Here, as indicated by the transmission amount in the right part in FIG. 3, in a case where the transmission rate is relatively low, even though the data transmission is performed and the transmission data has not been read from the buffer by the reception processing, the threshold value c that is the capacity of the buffer has a margin with respect to the total amount of data to be transmitted.

That is, as illustrated in the right part in FIG. 3, in a case where the transmission rate is low, even though the transmission data is not read from the buffer by the reception processing, the free space can be maintained as indicated by r1, r2, and r3 (c>r1>r2>r3).

However, in the Credit Based Flow Control method, even in a state where the transmission rate is low and there is a margin in the buffer, the receiving-side communication device reads the transmission data from the buffer and repeatedly executes the reception processing (signal processing) in all phases.

In this manner, in a case where the transmission rate is low and there is a margin in the buffer, it is possible to reduce the power consumption relating to the reception processing as long as the execution frequency of the reception processing (signal processing) by the receiving-side communication device can be reduced.

Thus, in the present disclosure, by causing the receiving-side communication device not to execute the reception processing (reading transmission data stored in the buffer and performing signal processing) until the transmission data temporarily buffered in the buffer exceeds a predetermined buffer amount, the execution frequency of the reception processing is reduced, and thereby the power consumption relating to the reception processing is reduced.

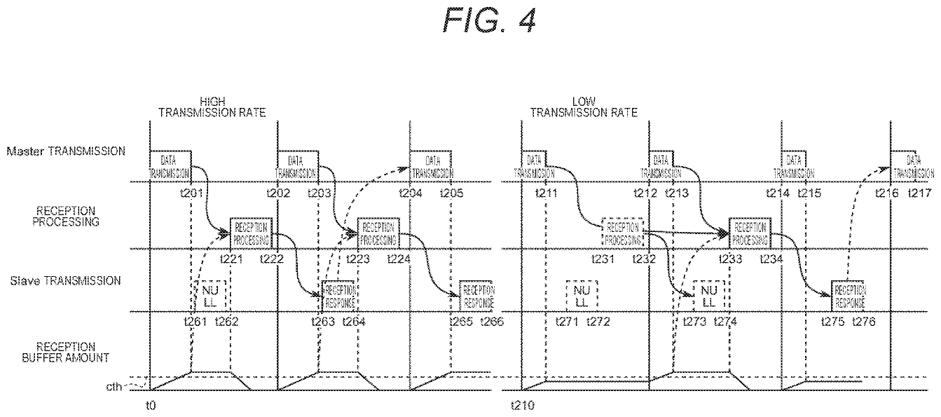

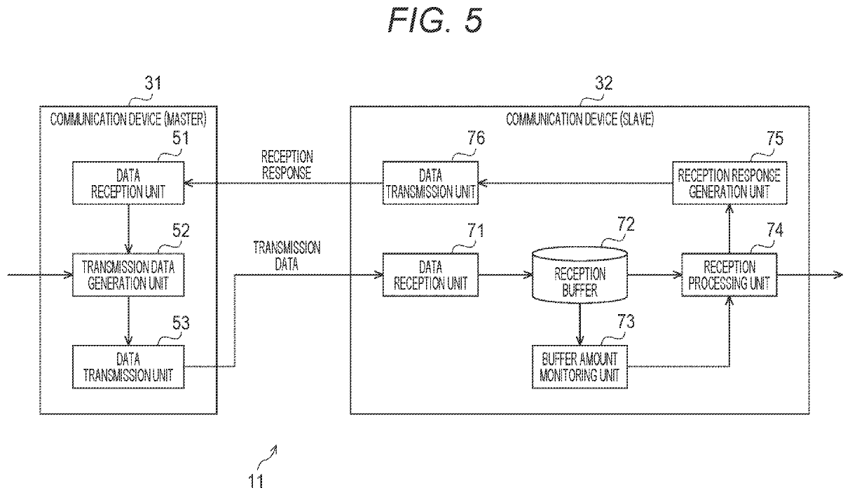

For example, as illustrated in the left part in FIG. 4, in a case where the transmission rate is high relative to the capacity of the buffer, in a case where the transmitting-side communication device executes the data transmission in times t0 to t201 and in times t202 to t203, the receiving-side communication device temporarily stores the transmitted data in the buffer so that the buffer amount exceeds the threshold value Cth set corresponding to the capacity of the buffer, as indicated by times t201 and t203.

Thus, in a case where the buffer amount exceeds the threshold value Cth, the receiving-side communication device reads the transmission data stored in the buffer and executes the reception processing (signal processing relating to the reception) as indicated by times t221 to t222 and times t223 to t224.

Then, in times t263 to 264 and in times t265 to t266 after the reception processing is performed, the receiving-side communication device reads the free space of the buffer, generates the credit information on the basis of the read free space of the buffer, and transmits the credit information as the reception response to the transmitting-side communication device.

That is, even in the present disclosure, in a case where the transmission rate is high relative to the capacity of the buffer, the reception processing is repeatedly executed in all phases similar to the case in the Credit Based Flow Control method.

On the other hands, in a case where the transmission rate is low relative to the capacity of the buffer, as illustrated in the right part in FIG. 4, in a case where the transmitting-side communication device executes the data transmission in times t210 to t211, even though the receiving-side communication device temporarily stores the transmitted data in the buffer, the buffer amount does not exceed the threshold value Cth set corresponding to the capacity of the buffer.

In this manner, in a case where the transmission rate is low relative to the capacity of the buffer and the buffer amount does not exceed the threshold value Cth, the receiving-side communication device skips the reception processing (signal processing relating to the reception) as indicated by a dotted line in times t231 to t232.

Note that, as indicated by a dotted line in times t231 to t232, the receiving-side communication device skips the reception processing (signal processing relating to the reception) so that the processing of transmitting the reception response including the credit information including the information on the free space of the buffer in time t273 to 274 is also skipped.

In the right part in FIG. 4, in a case where the transmitting-side communication device executes the data transmission as indicated by times t212 to t213, the receiving-side communication device temporarily stores the transmitted data in the buffer so that the buffer amount exceeds the threshold value Cth set corresponding to the capacity of the buffer, and therefore, the receiving-side communication device executes the reception processing (signal processing relating to the reception) in times t233 to t234.

In this case, in times t275 to t276 after the reception processing is performed, the receiving-side communication device reads the free space of the buffer, generates the credit information on the basis of the read free space of the buffer, and transmits the credit information as the reception response to the transmitting-side communication device.

In this manner, in the present disclosure, in a case where the transmission rate is low relative to the capacity of the buffer, in a case where the buffer amount does not exceed the predetermined threshold value Cth even though the transmission data is supplied from the transmitting-side communication device and the transmission data is buffered in the receiving-side communication device, the reception processing (signal processing relating to the reception) performed by reading the transmission data from the buffer and the processing of transmitting corresponding response information are omitted.

Therefore, in a case where the transmission rate is low relative to the capacity of the buffer, in the receiving-side communication device, it is possible to reduce the power consumption relating to the reception processing and the processing of transmitting the response information.

### 2. First Embodiment

Next, a configuration example of a communication system realizing the technique of the present disclosure will be described with reference to FIG. 5.

A communication system 11 of FIG. 5 includes a transmitting-side communication device (master) 31 that transmits transmission data, and a receiving-side communication device (slave) 32 that receives the transmission data transmitted from the communication device 31.

The transmitting-side communication device 31 is, for example, a media player or a smart phone that reproduces contents such as music and images, and the receiving-side communication device 32 is headphones, earphones, and the like that output the sound of the contents reproduced by the communication device 31.

The communication devices 31 and 32 realize the transmission and reception of the transmission data by, for example, the near field communication such as Bluetooth (registered trademark).

Note that the configurations of the communication devices 31 and 32 are not limited to the above-described media player and earphones, and any configuration may be used as long as a communication system that transmits and receives various kinds of transmission data can be realized.

The transmission device (master) 31 functioning as a master device transmits the transmission data supplied from an external device (not illustrated) or held by itself to the communication device (slave) 32 functioning as a slave device.

In a case where the transmission data transmitted from the communication device 31 is received, the communication device 32 temporarily buffers the transmission data until the transmission data exceeds a predetermined buffer amount, and executes reception processing of reading the buffered transmission data, performing predetermined signal processing, and outputting the transmission data in a case where the transmission data exceeds the predetermined buffer amount.

At this time, the communication device 32 generates the credit information on the basis of the information on the free space of the buffer after reading the transmission data by the reception processing, and transmits the reception response including the credit information to the communication device 31.

In a case where the reception response is received, the communication device 31 recognizes the free space of the buffer of the communication device 32 on the basis of the credit information included in the response signal, and transmits the transmission data of the data amount according to the recognized free space of the buffer to the communication device 32.

More specifically, the communication device 31 includes a data reception unit 51, a transmission data generation unit 52, and a data transmission unit 53.

The data reception unit 51 receives the reception response transmitted from the communication device 32, and outputs the reception response to the transmission data generation unit 52.

The transmission data generation unit 52 recognizes the free space of the buffer of the communication device 32 on the basis of the credit information included in the reception response supplied from the data reception unit 51, generates the transmission data of the data amount according to the recognized free space of the buffer of the communication device 32, and outputs the transmission data to the data transmission unit 53.

The data transmission unit 53 transmits the transmission data supplied from the transmission data generation unit 52, to the communication device 32.

The communication device 32 includes a data reception unit 71, a reception buffer 72, a buffer amount monitoring unit 73, a reception processing unit 74, a reception response generation unit 75, and a data transmission unit 76.

The data reception unit 71 receives the transmission data transmitted from the communication device 31, performs error correction processing and the like, and buffers the transmission data in the reception buffer 72.

The buffer amount monitoring unit 73 monitors the buffer amount of the transmission data buffered in the reception buffer 72, compares the buffer amount of the transmission data with a buffer amount which is a predetermined threshold value, and instructs the reception processing unit 74 to start the reception processing in a case where the buffer amount of the buffered transmission data exceeds the predetermined threshold value. The predetermined threshold value is set with a margin for the capacity of the reception buffer 72, and is set as a value such that the buffered transmission data does not overflow the reception buffer 72.

In a case where an instruction on the start of the reception processing is given by the buffer amount monitoring unit 73, the reception processing unit 74 reads the transmission data buffered in the reception buffer 72, performs the predetermined signal processing, and outputs the transmission data to a subsequent-stage device (not illustrated).

In a case where the transmission data is read from the reception buffer 72, the reception processing unit 74 recognizes the free space of the reception buffer 72 after the transmission data is read, and outputs information on the recognized free space of the reception buffer 72 to the reception response generation unit 75.

The reception processing unit 74 is operated in a low power state (or powered off) in a state other than executing a series of operations of reading the transmission data from the reception buffer 72, performing the predetermined signal processing, outputting the transmission data to the subsequent-stage device, and outputting the free space of the reception buffer to the reception response generation unit 75.

Therefore, the reception processing unit 74 is operated in a low power state until the instruction on the start of the reception processing is given by the buffer amount monitoring unit 73, releases the low power state to start a series of operations in a case where the instruction on the start of the reception processing is given, and returns to the low again in a case where the series of operations is ended.

In a case where the information on the free space of the reception buffer 72 is supplied from the reception processing unit 74, the reception response generation unit 75 generates the credit information on the basis of the free space of the reception buffer 72, and outputs the reception response including the generated credit information to the data transmission unit 76.

The data transmission unit 76 transmits the reception response supplied from the reception response generation unit 75, to the communication device 31.

With the configuration described above, the reception processing unit 74 is operated in a low power state until the instruction on the start of the reception processing is given due to the reception buffer 72 exceeding the buffer amount that is the predetermined threshold value, and therefore, it is possible to reduce the power consumption.

Therefore, the lower the transmission rate, the lower the frequency of the reception buffer 72 exceeding the buffer amount that is the predetermined threshold value, and thus, the period during which the reception processing unit 74 is operated in a low power state becomes longer, which makes it possible to further reduce the power consumption.

Furthermore, since the reception response generation unit 75 does not perform an operation of generating the reception response unless the reception processing unit 74 performs the reception processing, it is possible to reduce the power consumption in the reception response generation unit 75.

<Communication Processing by Communication System in FIG. 5>

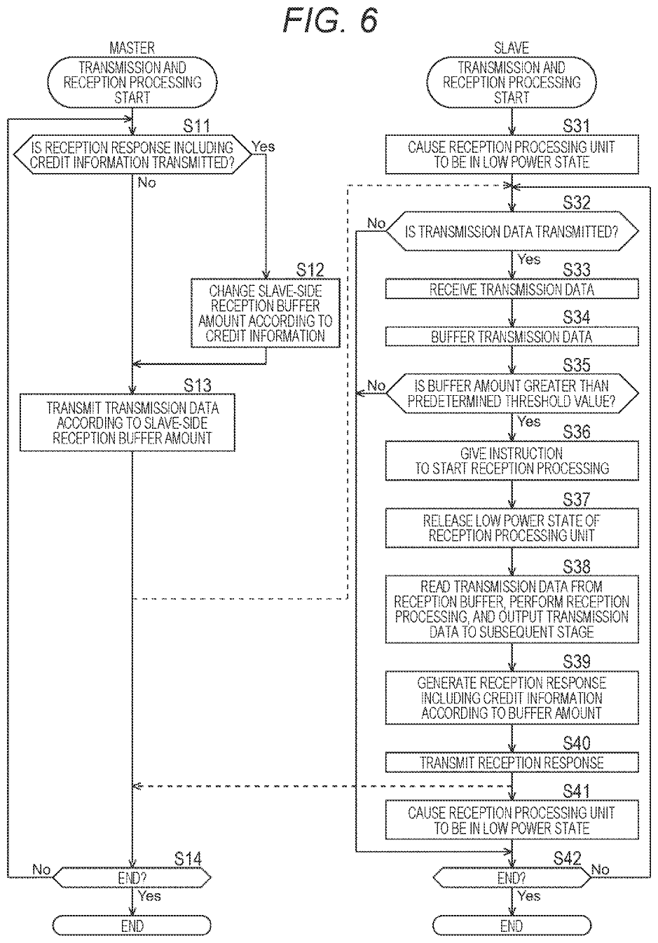

Next, the communication processing by the communication system in FIG. 5 will be described with reference to the flowchart in FIG. 6.

In step S11, the transmission data generation unit 52 of the communication device 31 controls the data reception unit 51 to determine whether or not the reception response including the credit information is transmitted from the communication device 32.

In step S11, in the first processing, since no reception response is transmitted from the communication device 32, it is considered that the reception response is not transmitted, and the processing proceeds to step S12.

In step S12, the transmission data generation unit 52 controls the data transmission unit 53 to transmit the transmission data of the data amount according to a reception buffer amount of the reception buffer 72 of the communication device 32 to the communication device 32.

On the other hand, in step S11, in the second and subsequent processing, in a case where the reception response is transmitted from the communication device 32, the processing proceeds to step S12.

In step S12, the transmission data generation unit 52 changes the reception buffer amount of the reception buffer 72 in the communication device 32 according to the credit information included in the reception response.

That is, in a case where the reception response is transmitted, the information on the reception buffer amount of the reception buffer 72, which is a set value for setting the data amount of transmission data to be transmitted, is changed according to the credit information included in the received reception response. Note that, the initial value of the reception buffer amount of the reception buffer 72, which is the set value for setting the data amount of the transmission data to be transmitted may be arbitrarily set with the maximum data amount as the upper limit.

In step S14, the transmission data generation unit 52 determines whether or not an instruction on the end of the operation is given, and in a case where the instruction on the end is not given, the processing returns to step S11 and the subsequent processing is repeated.

Then, in step S14, in a case where the instruction on the end is given, the processing is ended.

Furthermore, in the communication device 32, in step S31, the reception processing unit 74 of the communication device 32 switches the operation state to a low power state.

In step S32, the data reception unit 71 determines whether or not the transmission data is transmitted from the communication device 31.

In a case where it is determined in step S32 that the transmission data is transmitted, the processing proceeds to step S33.

In step S33, the data reception unit 71 receives the transmitted transmission data.

In step S34, the data reception unit 71 buffers the received transmission data in the reception buffer 72.

In step S35, the buffer amount monitoring unit 73 checks the buffer amount of the reception buffer 72, and determines whether or not the buffer amount is greater than the predetermined threshold value.

In a case where it is determined in step S35 that the buffer amount is greater than the predetermined threshold value, the processing proceeds to step S36.

In step S36, the buffer amount monitoring unit 73 instructs the reception processing unit 74 to start the reception processing.

In step S37, the reception processing unit 74 releases the low power state to be in a state of enabling execution of the reception processing on the basis of the instruction indicating the start of the reception processing from the buffer amount monitoring unit 73.

In step S38, the reception processing unit 74 reads the transmission data buffered in the reception buffer 72, performs the reception processing including predetermined signal processing, and outputs the transmission data to the subsequent-stage device. In this case, the reception processing unit 74 supplies the information on the free space of the reception buffer 72 after the transmission data is read from the reception buffer 72 by the reception processing, to the reception response generation unit 75.

In step S39, the reception response generation unit 75 generates outputs the reception response including the credit information based on the information on the free space of the reception buffer 72 supplied from the reception processing unit 74, and outputs the reception response to the data transmission unit 76.

In step S40, the data transmission unit 76 transmits the reception response supplied from the reception response generation unit 75, to the communication device 31.

In step S41, the reception processing unit 74 switches the operation state to a low power state.

In step S42, the data reception unit 71 determines whether or not the instruction on the end of the operation is given, and in a case where the instruction on the end is not given, the processing returns to step S32 and the subsequent processing is repeated.

Furthermore, in a case where the transmission data is not transmitted in step S32, the processing of steps S33 to S41 is skipped.

Moreover, in a case where the buffer amount of the reception buffer 72 is not greater than the predetermined threshold value in step S35, the processing of steps S36 to S41 is skipped.

By the processing described above, in a case where the transmission data is not transmitted, the reception processing unit 74 is in a low power state, and therefore, it is possible to reduce the power consumption.

Furthermore, even in a case where the transmission data is transmitted, the reception processing unit 74 is operated in a low power state until the buffer amount of the reception buffer 72 becomes greater than the predetermined threshold value, and the reception processing unit 74 is operated only in a case where the buffer amount reaches the predetermined threshold value. Therefore, it is possible to reduce the power consumption relating to the reception processing of the reception processing unit 74.

Therefore, the lower the transmission rate of the transmission data, the lower the frequency of the buffer amount of the reception buffer 72 becoming greater than the predetermined threshold value, and thus, the period during which the reception processing unit 74 is operated in a low power state becomes longer, which makes it possible to further reduce the power consumption.

Moreover, unless the reception processing unit 74 performs the reception processing, a notification of the free space of the reception buffer 72 is not provided so that the operation of the reception response generation unit 75 is not performed, and therefore, it is possible to reduce the power consumption relating to the operation of the reception response generation unit 75.

### 3. Second Embodiment

In the above description, an example has been described in which the reception processing by the reception processing unit 74 is not performed until the buffer amount of the reception buffer 72 exceeds the predetermined threshold value, so that the power consumption relating to the reception processing by the reception processing unit 74 is reduced. However, there is a risk in that the reception processing is not performed on the buffered transmission data in a case where the buffer amount does not exceed the predetermined threshold value.

Thus, in a case where the data amount (data size such as the number of bytes) of the transmission data exceeds the predetermined threshold value on the basis of the information on the data recorded in the header of the transmission data, the buffer amount may be monitored by the processing described above, and in a case where the transmission data does not exceed the predetermined threshold value, the received transmission data may be subjected to the reception processing without monitoring the buffer amount.

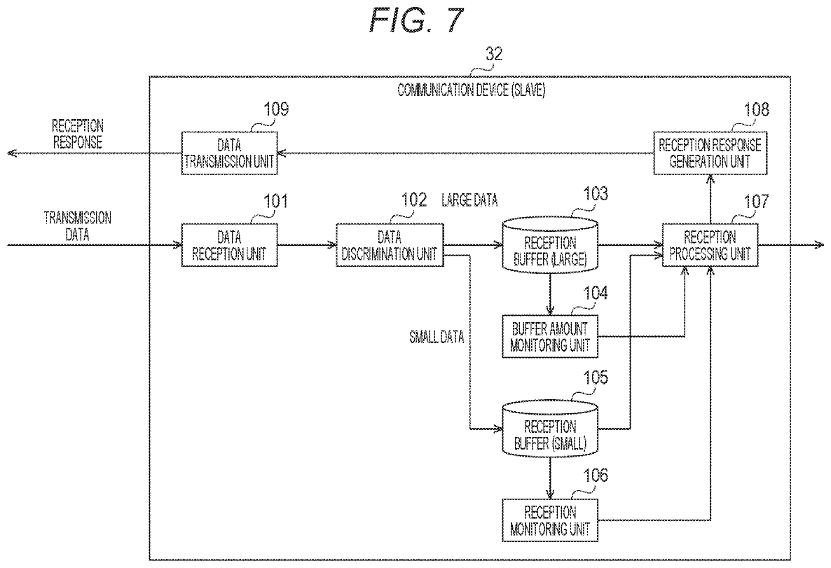

FIG. 7 illustrates a configuration example of the communication device 32 in which, in a case where the data amount of the transmission data exceeds the predetermined threshold value on the basis of the information on the data amount recorded in the header of the transmission data, the buffer amount is monitored by the processing described above, and in a case where the data amount of the transmission data does not exceed the predetermined threshold value, the received transmission data is subjected to the reception processing without monitoring the buffer amount.

The communication device 32 in FIG. 7 includes a data reception unit 101, a data discrimination unit 102, a reception buffer (large) 103 that buffers the transmission data of which the data amount is greater than the predetermined threshold value, a buffer amount monitoring unit 104, a reception buffer (small) 105 that buffers the transmission data of which the data amount is smaller than the predetermined threshold value, a reception monitoring unit 106, a reception processing unit 107, a reception response generation unit 108, and a data transmission unit 109.

Note that the data reception unit 101, the reception buffer (large) 103 that buffers the transmission data of which the data amount is greater than the predetermined threshold value, the buffer amount monitoring unit 104, the reception processing unit 107, the reception response generation unit 108, and the data transmission unit 109 in FIG. 7 are configured to have basically the same functions as the data reception unit 71, the reception buffer 72, the buffer amount monitoring unit 73, the reception processing unit 74, the reception response generation unit 75, and the data transmission unit 76 in FIG. 5, and thus the description thereof will be omitted.

That is, in the communication device 32 in FIG. 7, new configurations are the data discrimination unit 102, the reception buffer (small) 105, and the reception monitoring unit 106.

The data discrimination unit 102 buffers the transmission data of which the data amount is greater than the predetermined threshold value in the reception buffer (large) 103, and buffers the transmission data of which the data amount is smaller than the predetermined threshold value in the reception buffer (small) 105, on the basis of the information recorded in the header of the transmission data received by the data reception unit 101.

As a result, the reception buffer (large) 103 and the buffer amount monitoring unit 104 realize the same functions as the configurations in the reception buffer 72 and the buffer amount monitoring unit 73 in FIG. 5.

In a case where the transmission data is buffered in the reception buffer (small) 105, the reception monitoring unit 106 instructs the reception processing unit 107 to start the reception processing of the transmission data buffered in the reception buffer (small) 105.

Therefore, the reception processing unit 107 releases the low power state to start the reception processing by reading the transmission data which is buffered in the reception buffer (small) 105 and is smaller than the predetermined threshold value.

With such a configuration, it is suppressed that processing is ended while the data amount of the buffered transmission data does not exceed the predetermined threshold value so that the reception processing is not performed.

Note that the configuration of the communication device 31 is the same, the description thereof will be omitted.

<Communication Processing by Communication Device in FIG. 7>

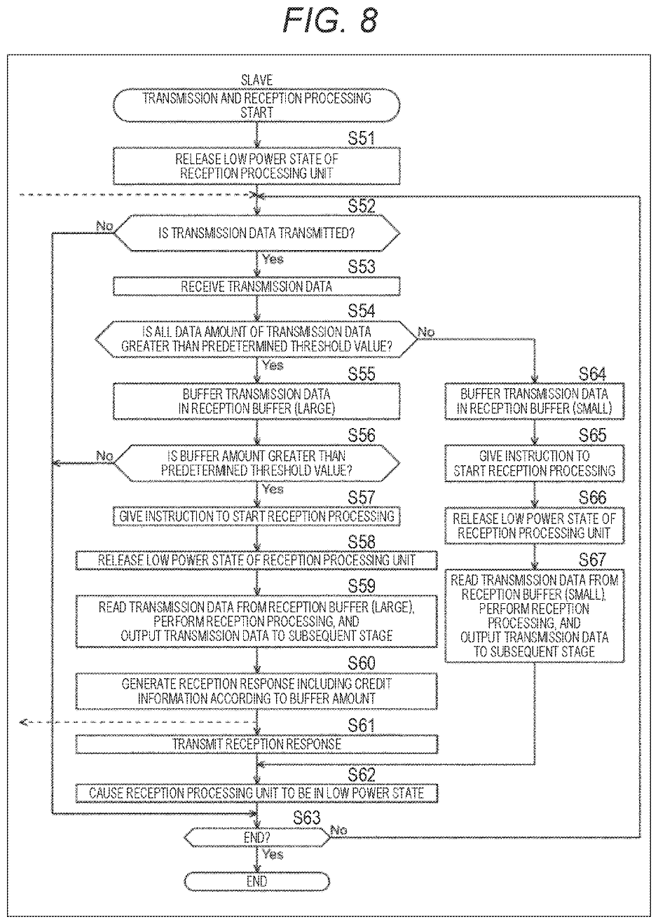

Next, the communication processing by the communication device in FIG. 7 will be described with reference to the flowchart in FIG. 8. Note that, since the processing of the communication device 31 is the same as the processing described with reference to the flowchart in FIG. 6, the description thereof will be omitted, and the same applies to the following description.

Furthermore, processing of steps S51 to S53 and S55 to S63 of the flowchart in FIG. 8 is the same as the processing of steps S31 to S42 of the flowchart in FIG. 6, and thus the description thereof will be omitted.

That is, by the processing of steps S51 to S53, in a case where the transmission data transmitted from the communication device 31 is received, the data reception unit 101 outputs the received transmission data to the data discrimination unit 102.

In step S54, the data discrimination unit 102 determines whether or not the transmission data has a data amount greater than the predetermined threshold value of the buffer amount to be buffered in the reception buffer (large) 103 on the basis of the information on the data amount included in the header of the supplied transmission data.

In a case where it is determined in step S54 that the transmission data has a data amount greater than the predetermined threshold value of the buffer amount to be buffered in the reception buffer (large) 103, the processing proceeds to step S55, and the data discrimination unit 102 buffers the transmission data in the reception buffer (large) 103.

Then, by performing the processing of steps S56 to S62, in a case where the buffer amount of the reception buffer (large) 103 exceeds the predetermined threshold value, the buffer amount monitoring unit 104 causes the reception processing unit 107 to perform the reception processing.

Furthermore, in a case where it is determined in step S54 that the transmission data has a data amount smaller than the predetermined threshold value of the buffer amount to be buffered in the reception buffer (large) 103, the processing proceeds to step S64.

In step S64, the data discrimination unit 102 buffers the transmission data in the reception buffer (small) 105.

In step S65, the reception monitoring unit 106 recognizes that the transmission data is buffered in the reception buffer (small) 105, and instructs the reception processing unit 107 to start the reception processing.

In step S66, the reception processing unit 107 releases the low power state to be in a state of enabling execution of the reception processing on the basis of the instruction indicating the start of the reception processing from the reception monitoring unit 106.

In step S67, the reception processing unit 107 reads the transmission data buffered in the reception buffer (small) 105, performs the reception processing including predetermined signal processing, and outputs the transmission data to the subsequent-stage device.

By this processing, in a case where the transmission data has a data amount smaller than the predetermined threshold value of the buffer amount to be buffered in the reception buffer (small) 105, the reception processing is immediately performed by the reception processing unit 107.

As a result, it is possible to avoid a state in which the buffer amount of the transmission data buffered in the reception buffer (large) 103 does not reach the predetermined threshold value and thus the reception processing is not performed, while reducing the power consumption relating to the reception processing by the reception processing unit 107.

Furthermore, in a case where the transmission data with a small data amount is transmitted, the reception response is not generated, and thus it is also possible to reduce the power consumption required for the operation of the reception response generation unit 108. That is, even in a case where the transmission data with a small data amount is read from the reception buffer (large) 103, since the change of the free space is small, it is possible to reduce the power consumption of the reception response generation unit 108 by suppressing repeated transmission of the reception response including the credit information with a small change.

Note that, in the above description, an example has been described in which the necessity of monitoring the buffer amount is switched on the basis of the data amount in the information on the data, but the necessity of monitoring the buffer amount may be switched on the basis of other information relating to the data.

For example, the necessity of monitoring the buffer amount may be switched on the basis of the type of the data, in a case where the type of the data is a control system such as a reset command, the data may be processed sequentially, and in a case where the type of the data indicates a file transfer command, the buffer amount may be monitored.

### 4. Third Embodiment

In the above description, an example has been described in which a state in which the buffer amount does not meet the predetermined threshold value so that the reception processing is not performed is avoided by buffering the transmission data in the reception buffer (small) 105 and immediately performing the reception processing in a case where the data amount of the transmission data is smaller than the predetermined threshold value on the basis of the information of the header of the transmission data.

However, an elapsed time after the buffering in the reception buffer is measured, and the reception processing may be forcibly performed in a case where the buffer amount does not meet the predetermined threshold value and reception processing is not performed even after a predetermined time has elapsed.

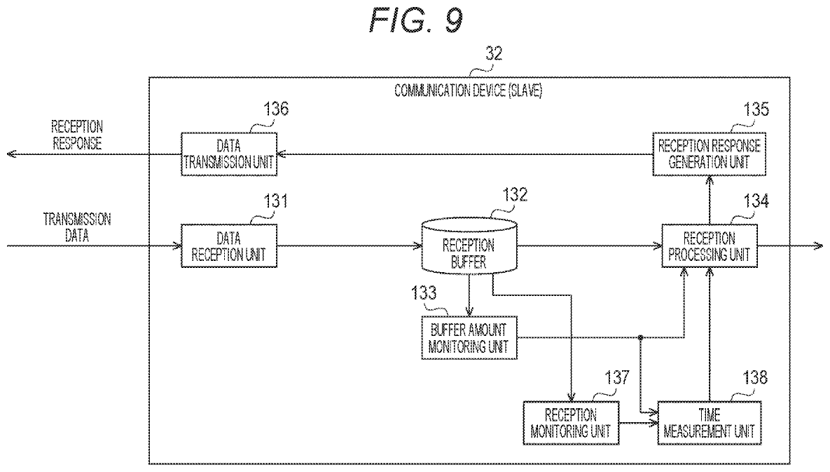

FIG. 9 illustrates a configuration example of the communication device 32 in which the elapsed time after the buffering in the reception buffer is measured, and the reception processing is forcibly performed in a case where the buffer amount does not exceed the predetermined threshold value and reception processing is not performed even after a predetermined time has elapsed.

The communication device 32 in FIG. 9 is configured to include a data reception unit 131, a reception buffer 132, a buffer amount monitoring unit 133, a reception processing unit 134, a reception response generation unit 135, a data transmission unit 136, a reception monitoring unit 137, and a time measurement unit 138.

Note that the data reception unit 131, the reception buffer 132, the buffer amount monitoring unit 133, the reception processing unit 134, the reception response generation unit 135, and the data transmission unit 136 in FIG. 9 are configured to have the same functions as the data reception unit 71, the reception buffer 72, the buffer amount monitoring unit 73, the reception processing unit 74, the reception response generation unit 75, and the data transmission unit 76 in FIG. 5, and thus the description thereof will be omitted.

That is, in the communication device 32 in FIG. 9, new configurations are the reception monitoring unit 137 and the time measurement unit 138.

The reception monitoring unit 137 monitors the timing at which the transmission data is buffered in the reception buffer 132, and in a case where the transmission data is buffered in the reception buffer 132, the reception buffer 132 notifies the time measurement unit 138 of the information indicating that the transmission data is buffered in the reception buffer 132.

In a case where a notification indicating the first buffering is made after an instruction on the start of the reception processing is given on the basis of the instruction from the buffer amount monitoring unit 133 to the reception processing unit 134 to start the reception processing and the notification from the reception monitoring unit 137 indicating that the transmission data is buffered in the reception buffer 132, the time measurement unit 138 measures the elapsed time from the start of the buffering in the reception buffer 132.

Then, in a case where the elapsed time from the start of the buffering in the reception buffer 132 is longer than a predetermined time, the time measurement unit 138 regards the transmission data buffered in the reception buffer 132 as remaining without being subjected to the reception processing, and instructs the reception processing unit 134 to start the reception processing.

By this processing, it is possible to prevent the transmission data from remaining buffered in the reception buffer 132 without being subjected to the reception processing.

Note that the configuration of the communication device 31 is the same, the description thereof will be omitted.

<Communication Processing by Communication Device in FIG. 9>

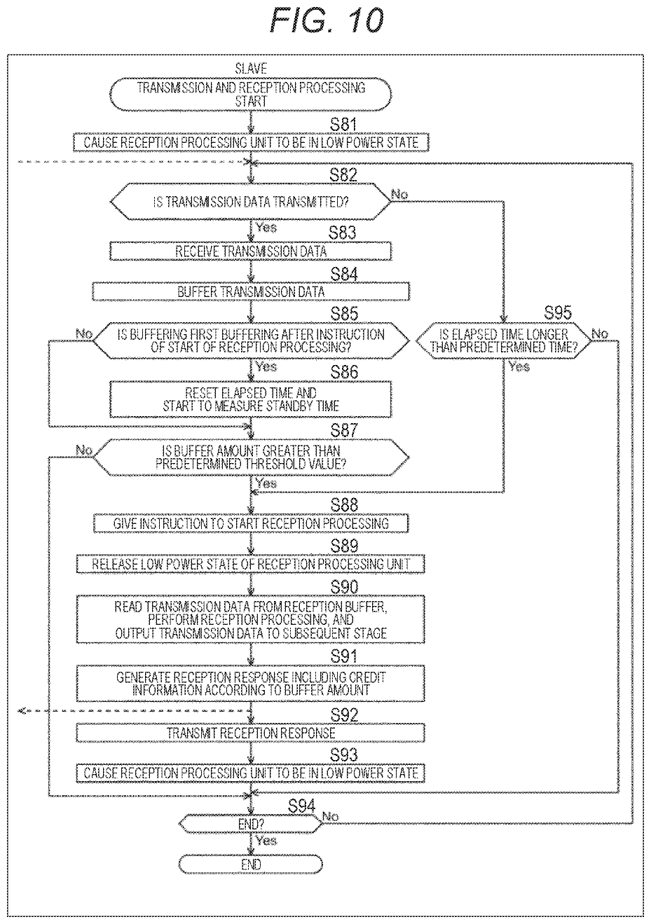

Next, the communication processing by the communication device 32 in FIG. 9 will be described with reference to the flowchart in FIG. 10. Note that, since the processing of the communication device 31 is the same as the processing described with reference to the flowchart in FIG. 6, the description thereof will be omitted.

Furthermore, processing of steps S81 to S84 and S87 to S94 of the flowchart in FIG. 10 is the same as the processing of steps S31 to S42 of the flowchart in FIG. 6, and thus the description thereof will be omitted.

That is, by the processing of steps S81 to S84, the data reception unit 131 receives the transmission data transmitted from the communication device 31, and the received transmission data is buffered in the reception buffer 132. In this case, the reception monitoring unit 137 notifies the time measurement unit 138 of the information indicating that the transmission data is buffered in the reception buffer 132.

In step S85, the time measurement unit 138 determines whether or not the buffering is first buffering after the buffer amount monitoring unit 133 instructs the reception processing unit 134 to start the reception processing.

In step S85, in a case where the buffering is first buffering after the buffer amount monitoring unit 133 instructs the reception processing unit 134 to start the reception processing, the processing proceeds to step S86.

In step S86, the time measurement unit 138 resets the elapsed time, and starts to measure an elapsed time from the start of buffering in the reception buffer 132.

Note that, in step S85, in a case where the buffering is not the first buffering after the buffer amount monitoring unit 133 instructs the reception processing unit 134 to start the reception processing, the processing of step S86 is skipped.

That is, by this processing, the measurement of the elapsed time from the start of the buffering in the reception buffer 132 is started.

It is regarded in step S82 that there is no transmission of the transmission data, and the processing proceeds to step S95.

In step S95, the time measurement unit 138 determines whether or not the elapsed time from the buffering in the reception buffer 132 is longer than the predetermined time, that is, whether or not a state in which the buffer amount does not exceed the predetermined threshold value after the start of buffering is continued for a time longer than the predetermined time.

In a case where it is regarded in step S95 that the elapsed time from the start of the buffering in the reception buffer 132 is longer than the predetermined time, the processing proceeds to step S88.

That is, by this processing, in a case where a state where the buffer amount of the reception buffer 132 does not exceed the predetermined threshold value exceeds the predetermined time, the signal processing by the reception processing unit 134 is forcibly started.

As a result, it is possible to avoid a state in which the buffer amount of the transmission data buffered in the reception buffer 132 does not reach the predetermined threshold value and thus the reception processing is not performed, while reducing the power consumption relating to the reception processing by the reception processing unit 134.

Note that, in step S95, in a case where the elapsed time from the start of the buffering in the reception buffer 132 is not longer than the predetermined time, the processing proceeds to step S94.

### 5. Fourth Embodiment

In the above description, an example has been described in which a state in which the buffer amount does not meet the predetermined threshold value so that the reception processing is not performed is avoided by forcibly performing the reception processing in a case where the predetermined time elapses from the start of the buffering in the reception buffer 132.

However, the power consumption may be reduced to the extent that the reception buffer does not become full by measuring the transmission amount (transmission rate) of the transmission data and setting the predetermined threshold value for the buffer amount according to the transmission amount.

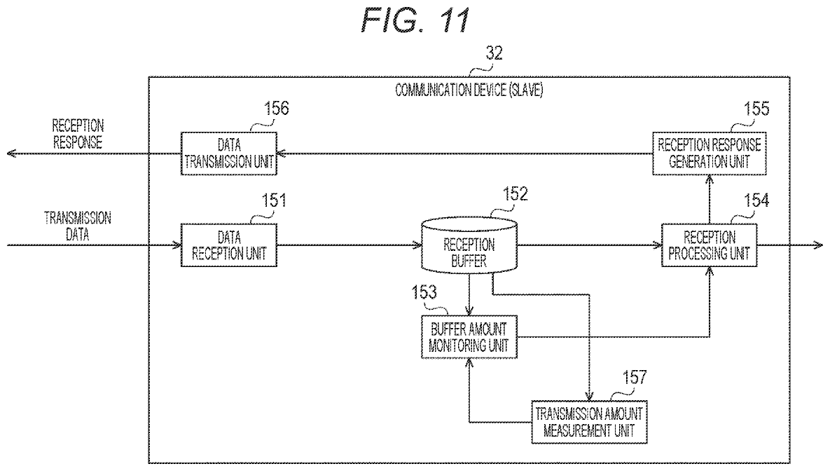

FIG. 11 illustrates a configuration example of the communication device 32 in which the transmission amount (transmission rate) of the transmission data is measured and the predetermined threshold value is set for the buffer amount according to the transmission amount.

The communication device 32 in FIG. 11 is configured to include a data reception unit 151, a reception buffer 152, a buffer amount monitoring unit 153, a reception processing unit 154, a reception response generation unit 155, a data transmission unit 156, and a transmission amount measurement unit 157.

Note that the data reception unit 151, the reception buffer 152, the buffer amount monitoring unit 153, the reception processing unit 154, the reception response generation unit 155, and the data transmission unit 156 in FIG. 11 are configured to have basically the same functions as the data reception unit 71, the reception buffer 72, the buffer amount monitoring unit 73, the reception processing unit 74, the reception response generation unit 75, and the data transmission unit 76 in FIG. 5, and thus the description thereof will be omitted.

That is, the communication device 32 in FIG. 11 is different from the communication device 32 in FIG. 5 in the configurations of the buffer amount monitoring unit 153 and the transmission amount measurement unit 157.

In a case where the transmission data is buffered in the reception buffer 152, the transmission amount measurement unit 157 measures the transmission amount (transmission rate) of the transmission data, and notifies the buffer amount monitoring unit 153 of the transmission amount.

The buffer amount monitoring unit 153 has basically the same function as the buffer amount monitoring unit 73, but moreover, the buffer amount monitoring unit 153 obtains the transmission amount (transmission rate) by, for example, statistical processing on the basis of the predetermined number of pieces of the latest transmission data buffered in the reception buffer 152, and sets the predetermined threshold value for the buffer amount of the reception buffer 152.

That is, for example, in order to suppress the buffer fullness of the reception buffer 152 which reaches the maximum capacity of the reception buffer by repeating the buffering of the transmission data a predetermined number of times in a case where the transmission amount is large (the transmission rate is high), for example, the buffer amount obtained by subtracting a larger value than an average data amount of the transmission data statistically obtained from the latest transmission data, from the reception buffer 152 may be set as the predetermined threshold value.

Furthermore, in order to suppress the occurrence of the transmission data that remains buffered in the reception buffer 152 without being subjected to reception processing in a case where the transmission amount is small (the transmission rate is low) and the reception buffer 152 has sufficient capacity, the buffer amount monitoring unit 153 may set the predetermined threshold value to a larger value on the basis of the average data amount of the transmission data statistically obtained from the latest transmission data, for example.

<Setting Processing for Predetermined Threshold Value by Communication Device in FIG. 11>

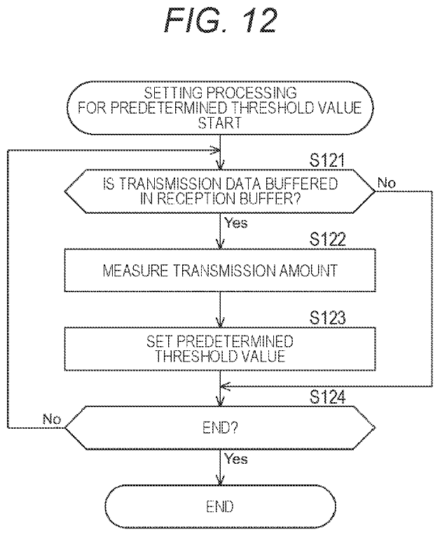

Next, the setting processing for the predetermined threshold value by the communication device 32 in FIG. 11 will be described with reference to the flowchart in FIG. 12. Note that, the setting processing for the predetermined threshold value is executed in parallel with the communication processing described with reference to FIG. 6.

That is, in step S121, the transmission amount measurement unit 157 determines whether or not the transmission data is buffered in the reception buffer 152.

In step S121, in a case where the transmission data is buffered in the reception buffer 152, the processing proceeds to step S122.

In step S122, the transmission amount measurement unit 157 measures and stores the data amount of the transmission data newly buffered in the reception buffer 152.

In step S123, the buffer amount monitoring unit 153 obtains the transmission amount (transmission rate) on the basis of the information on the data amount of the plurality of pieces of the latest transmission data stored in the transmission amount measurement unit 157, and sets the predetermined threshold value for the buffer amount of the reception buffer 152 based on the transmission rate.

In step S124, the buffer amount monitoring unit 153 determines whether or not an instruction on the end of the processing is given, and in a case where the instruction on the end is not given, the processing returns to step S121.

Then, in step S124, in a case where the instruction on the end is given, the setting processing for the predetermined threshold value is ended.

Note that, in step S121, in a case where the transmission data is not received in the reception buffer, the processing of steps S122 and S123 is skipped.

By the processing described above, since the predetermined threshold value for the buffer amount of the reception buffer 152 is set on the basis of the latest transmission amount (transmission rate), the instruction on the start of the reception processing is given on the basis of the appropriate buffer amount, and therefore, the power consumption can be reduced to the extent that the reception buffer 152 does not become full.

Furthermore, since the predetermined threshold value for the buffer amount of the reception buffer 152 is repeatedly set on the basis of the data amount of the latest transmission data, the predetermined threshold value can be dynamically changed according to the communication state, and therefore, it is possible to realize an appropriate reduction in the power consumption according to the communication state.

### 6. Example Executed by Software

Meanwhile, the above-described series of processing can be executed by hardware, but can also be executed by software. In a case where the series of processing is executed by software, a program constituting the software is installed from a recording medium to a computer incorporated in dedicated hardware or, for example, a general-purpose computer or the like capable of executing various functions by installing various programs.

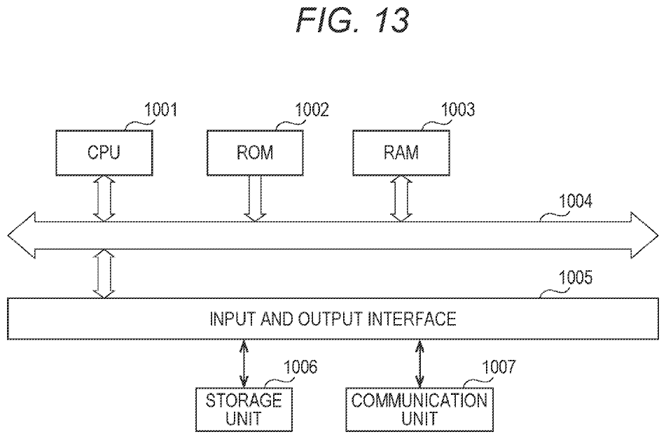

FIG. 13 illustrates a configuration example of a general-purpose computer. A personal computer includes a central processing unit (CPU) 1001. An input and output interface 1005 is connected to the CPU 1001 via a bus 1004. A read only memory (ROM) 1002 and a random access memory (RAM) 1003 are connected to the bus 1004.

A storage unit 1006 including flash memory or the like for storing programs and various kinds of data, and a communication unit 1007 that performs Bluetooth (registered trademark) communication are connected to the input and output interface 1005.

The CPU 1001 executes various kinds of processing according to a program stored in the ROM 1002 or a program that is installed in the storage unit 1006, and is loaded from the storage unit 1006 to the RAM 1002. Furthermore, data and the like required for the CPU 1001 to execute various kinds of processing are appropriately stored in the RAM 1003.

In the computer configured as described above, for example, the CPU 1001 loads a program stored in the storage unit 1006 into the RAM 1003 via the input and output interface 1005 and the bus 1004 and executes the program, and thereby the above-described series of processing is performed.

The program executed by the computer (CPU 1001) can be provided, for example, from the input and output interface 1005 via a wired or wireless transmission medium.

In the computer, the program can be installed in the storage unit 1006 from the outside via the input and output interface 1005. Furthermore, the program can be installed in the storage unit 1006 by being received by the communication unit 1007 via a wired or wireless transmission medium. In addition, the program can be installed in the ROM 1002 or the storage unit 1006 in advance.

Note that the program executed by the computer may be a program in which processing is performed in time series in the order described in the present specification, or may be a program in which processing is performed in parallel or at necessary timing such as when a call is made.

Note that, the CPU 1001 in FIG. 13 realizes the functions of the buffer amount monitoring unit 73, the reception processing unit 74, and the reception response generation unit in FIG. 5, the data discrimination unit 102, the buffer amount monitoring unit 104, the reception monitoring unit 106, the reception processing unit 107, and the reception response generation unit 108 in FIG. 7, the buffer amount monitoring unit 133, the reception processing unit 134, the reception response generation unit 135, the reception monitoring unit 137, and the time measurement unit 138 in FIG. 9, and the buffer amount monitoring unit 153, the reception processing unit 154, the reception response generation unit 155, and the transmission amount measurement unit 157 in FIG. 11.

Furthermore, the CPU 1001 may realize the functions of the reception processing unit 74 and the reception response generation unit 75 in FIG. 5, the reception processing unit 107 and the reception response generation unit 108 in FIG. 7, the reception processing unit 134 and the reception response generation unit 135 in FIG. 9, and the reception processing unit 154 and the reception response generation unit 155 in FIG. 11, and the communication unit 1006 may realize the functions of the buffer amount monitoring unit 73 in FIG. 5, the data discrimination unit 102 and the buffer amount monitoring unit 104 in FIG. 7, the buffer amount monitoring unit 133, the reception monitoring unit 137, and the time measurement unit 138 in FIG. 9, and the buffer amount monitoring unit 153 and the transmission amount measurement unit 157 in FIG. 11.

Furthermore, in the present specification, a system means a set of a plurality of components (devices, modules (parts), and the like) and it does not matter whether or not all the components are in the same housing. Therefore, a plurality of devices that is housed in separate housings and connected via a network, and one device in which a plurality of modules is housed in one housing are both systems.

Note that the embodiments of the present disclosure are not limited to the above-described embodiments, and various modifications can be made without departing from the gist of the present disclosure.

For example, the present disclosure can have a configuration of cloud computing in which one function is shared and processed in cooperation by a plurality of devices via a network.

Furthermore, each step described in the above-described flowcharts can be executed by one device or can be shared and executed by a plurality of devices.

Moreover, in a case where a plurality of kinds of processing is included in one step, the plurality of kinds of processing included in the one step can be executed by one device or can be shared and executed by a plurality of devices.

Note that the present disclosure can also have the following configurations.

<1> A communication device including:
a reception buffer monitoring unit that monitors a reception buffer that buffers transmission data; and
a reading unit that reads the transmission data from the reception buffer on the basis of a monitoring result of the reception buffer monitoring unit.

<2> The communication device according to <1>,
in which the reception buffer monitoring unit monitors whether or not a buffer amount of the transmission data buffered in the reception buffer exceeds a predetermined threshold value, and
in a case where the buffer amount of the reception buffer exceeds the predetermined threshold value on the basis of the monitoring result of the reception buffer monitoring unit, the reading unit reads the transmission data from the reception buffer.

<3> The communication device according to <2>,
in which the reception buffer monitoring unit sets the predetermined threshold value on the basis of a latest transmission rate of the transmission data.

<4> The communication device according to <2>,
in which in a case where the buffer amount of the reception buffer exceeds the predetermined threshold value, the reading unit releases a low power state, and reads the transmission data from the reception buffer, and in a case where reading the transmission data is ended, the reading unit returns to the low power state.

<5> The communication device according to any one of <1> to <4>, further including:
another reception buffer which is different from the reception buffer and which buffers the transmission data smaller than a predetermined data amount; and
another reception buffer monitoring unit that monitors that the transmission data smaller than the predetermined data amount is buffered in the other reception buffer,
in which the reception buffer buffers the transmission data larger than the predetermined data amount, and
the reading unit
reads the transmission data larger than the predetermined data amount from the reception buffer in a case where the buffer amount of the reception buffer exceeds the predetermined threshold value on the basis of the monitoring result of the reception buffer monitoring unit, and
reads the transmission data smaller than the predetermined data amount from the other buffer in a case where the transmission data smaller than the predetermined data amount is buffered in the other reception buffer on the basis of a monitoring result of the other reception buffer monitoring unit.

<6> The communication device according to <5>, further including:
a discrimination unit that discriminates whether or not the transmission data is larger than the predetermined data amount,
in which the discrimination unit buffers the transmission data larger than the predetermined data amount in the reception buffer, and buffers the transmission data smaller than the predetermined data amount in the other reception buffer.

<7> The communication device according to any one of <1> to <4>,
in which in a case where a buffer amount of the reception buffer does not exceed a predetermined threshold value on the basis of a monitoring result of the reception buffer monitoring unit, the reading unit reads the transmission data from the reception buffer in a case where a predetermined time elapses from a start of buffering of the transmission data in the reception buffer.

<8> The communication device according to <7>, further including:
a time measurement unit that measures an elapsed time from the start of the buffering of the transmission data in the reception buffer,
in which in a case where the buffer amount of the reception buffer does not exceed the predetermined threshold value on the basis of the monitoring result of the reception buffer monitoring unit, the reading unit reads the transmission data from the reception buffer in a case where a predetermined time elapses from the start of the buffering of the transmission data in the reception buffer on the basis of the elapsed time measured by the time measurement unit.

<9> The communication device according to any one of <1> to <4>,
in which the reading unit reads a free space of the reception buffer in a case of reading the transmission data from the reception buffer on the basis of the monitoring result of the reception buffer monitoring unit, and
the communication device further includes a reception response generation unit that generates a reception response which includes credit information based on the free space of the reception buffer and is to be transmitted to another communication device that transmits the transmission data.

<10> The communication device according to <9>,
in which the transmission data is a data amount adjusted on the basis of the free space of the reception buffer corresponding to the credit information included in the reception response, in the other communication device.

<11> A communication method including steps of:
monitoring a reception buffer that buffers transmission data; and
reading the transmission data from the reception buffer on the basis of a monitoring result.

<12> A program causing a computer to function as:
a reception buffer monitoring unit that monitors a reception buffer that buffers transmission data; and
a reading unit that reads the transmission data from the buffer on the basis of a monitoring result of the reception buffer monitoring unit.

<13> A communication system including a first communication device that transmits transmission data and a second communication device that receives the transmission data,
in which the first communication device includes
a transmission unit that transmits the transmission data, and
the second communication device includes
a reception buffer monitoring unit that monitors a reception buffer that buffers the transmission data, and
a reading unit that reads the transmission data from the reception buffer on the basis of a monitoring result of the reception buffer monitoring unit.

### REFERENCE SIGNS LIST

11 Communication system
31, 32 Communication device
51 Data reception unit
52 Transmission data generation unit
53 Data transmission unit
71 Data reception unit
72 Reception buffer
73 Buffer amount monitoring unit
74 Reception processing unit
75 Reception response generation unit
76 Data transmission unit
101 Data reception unit
102 Data discrimination unit
103 Reception buffer (large)
104 Buffer amount monitoring unit
105 Reception buffer (small)
106 Reception monitoring unit
107 Reception processing unit
108 Reception response generation unit
109 Data transmission unit
131 Data reception unit
132 Reception buffer
133 Buffer amount monitoring unit
134 Reception processing unit
135 Reception response generation unit
136 Data transmission unit
137 Reception monitoring unit
138 Time measurement unit
151 Data reception unit
152 Reception buffer
153 Buffer amount monitoring unit
154 Reception processing unit
155 Reception response generation unit
156 Data transmission unit
157 Transmission amount measurement unit

1. A communication device comprising:
a reception buffer monitoring unit that monitors a reception buffer that buffers transmission data; and
a reading unit that reads the transmission data from the reception buffer on a basis of a monitoring result of the reception buffer monitoring unit.

2. The communication device according to claim 1,
wherein the reception buffer monitoring unit monitors whether or not a buffer amount of the transmission data buffered in the reception buffer exceeds a predetermined threshold value, and
in a case where the buffer amount of the reception buffer exceeds the predetermined threshold value on a basis of the monitoring result of the reception buffer monitoring unit, the reading unit reads the transmission data from the reception buffer.

3. The communication device according to claim 2,
wherein the reception buffer monitoring unit sets the predetermined threshold value on a basis of a latest transmission rate of the transmission data.

4. The communication device according to claim 2,
wherein in a case where the buffer amount of the reception buffer exceeds the predetermined threshold value, the reading unit releases a low power state, and reads the transmission data from the reception buffer, and in a case where reading the transmission data is ended, the reading unit returns to the low power state.

5. The communication device according to claim 1, further comprising:
another reception buffer which is different from the reception buffer and which buffers the transmission data smaller than a predetermined data amount; and
another reception buffer monitoring unit that monitors that the transmission data smaller than the predetermined data amount is buffered in the other reception buffer,
wherein the reception buffer buffers the transmission data larger than the predetermined data amount, and
the reading unit
reads the transmission data larger than the predetermined data amount from the reception buffer in a case where the buffer amount of the reception buffer exceeds the predetermined threshold value on a basis of the monitoring result of the reception buffer monitoring unit, and
reads the transmission data smaller than the predetermined data amount from the other buffer in a case where the transmission data smaller than the predetermined data amount is buffered in the other reception buffer on a basis of a monitoring result of the other reception buffer monitoring unit.

6. The communication device according to claim 5, further comprising:
a discrimination unit that discriminates whether or not the transmission data is larger than the predetermined data amount,
wherein the discrimination unit buffers the transmission data larger than the predetermined data amount in the reception buffer, and buffers the transmission data smaller than the predetermined data amount in the other reception buffer.

7. The communication device according to claim 1,
wherein in a case where a buffer amount of the reception buffer does not exceed a predetermined threshold value on a basis of a monitoring result of the reception buffer monitoring unit, the reading unit reads the transmission data from the reception buffer in a case where a predetermined time elapses from a start of buffering of the transmission data in the reception buffer.

8. The communication device according to claim 7, further comprising:
a time measurement unit that measures an elapsed time from the start of the buffering of the transmission data in the reception buffer,
wherein in a case where the buffer amount of the reception buffer does not exceed the predetermined threshold value on a basis of the monitoring result of the reception buffer monitoring unit, the reading unit reads the transmission data from the reception buffer in a case where a predetermined time elapses from the start of the buffering of the transmission data in the reception buffer on a basis of the elapsed time measured by the time measurement unit.

9. The communication device according to claim 1,
wherein the reading unit reads a free space of the reception buffer in a case of reading the transmission data from the reception buffer on a basis of the monitoring result of the reception buffer monitoring unit, and
the communication device further comprises a reception response generation unit that generates a reception response which includes credit information based on the free space of the reception buffer and is to be transmitted to another communication device that transmits the transmission data.

10. The communication device according to claim 9,
wherein the transmission data is a data amount adjusted on a basis of the free space of the reception buffer corresponding to the credit information included in the reception response, in the other communication device.

11. A communication method comprising steps of:
monitoring a reception buffer that buffers transmission data; and
reading the transmission data from the reception buffer on a basis of a monitoring result.

12. A program causing a computer to function as:
a reception buffer monitoring unit that monitors a reception buffer that buffers transmission data; and
a reading unit that reads the transmission data from the reception buffer on a basis of a monitoring result of the reception buffer monitoring unit.

13. A communication system including a first communication device that transmits transmission data and a second communication device that receives the transmission data,
wherein the first communication device includes
a transmission unit that transmits the transmission data, and
the second communication device includes
a reception buffer monitoring unit that monitors a reception buffer that buffers the transmission data, and
a reading unit that reads the transmission data from the reception buffer on a basis of a monitoring result of the reception buffer monitoring unit.
